(19) United States
(12) Patent Application Publication
(10) Pub. No.: US 2026/0350546 A1
(43) Pub. Date: Nov. 5, 2026

(54) AUTOMATED EMAIL AND DOCUMENT PROCESSING SYSTEM

(71) Applicant: Riverside Assessments, LLC, Itasca, IL (US)

(72) Inventors: Leecox Omollo, Chicago, IL (US); Om Prakash, Buffalo Grove, IL (US)

(21) Appl. No.: 19/196,539

(22) Filed: May 1, 2025

(51) Int. Cl. G06Q 10/107; G06V 10/764; G06V 30/42

(52) U.S. Cl. CPC G06Q 10/107; G06V 10/764; G06V 30/42

(57) ABSTRACT

Systems and methods for the automated processing of emails and email attachments. The system may be configured to receive documents through email as attachments. Images in the received email may be filtered out and email may be merged with the attachments into a single merged document. The single merged document may be analyzed by one or more machine learning models to identify a document type and extract one or more data elements. Based on the analysis of the single merged document, the identified document type and the extracted data elements, the system may perform one or more verification, validation and exception handling processes, before trigging one or more distribution rules.

### FIELD

The present invention relates generally to systems, tools and methods to analyze and process emails and other documents received from customers.

### BACKGROUND

Processing of emails and attached documents traditionally requires manual analysis and routing of received documents. In systems that receive emails and documents from large number of clients, each using documents of different formats, the task of manually and/or automatically processing said documents becomes unmanageable and inaccurate.

### SUMMARY

The systems and methods described herein provide for automated email and email attachment processing. The system may comprise one or more mail servers, wherein the one or more mail servers are configured to receive one or more customer emails from one or more customers, wherein each of the one or more customer emails comprises an email binary and one or more email attachments.

In some embodiments, the system may further comprise one or more application servers. The one or more application servers may comprise a decryption module and an email process module. In some embodiments, the decryption module may be configured to decrypt one or more email attachments that are unable to be directly deserialized.

In some embodiments, the email process module may be configured to receive, from the one or more mail servers, a first customer email. The email binary of the first customer email and the one or more email attachments of the first customer email may then be deserialized.

In some embodiments, the deserialized email binary and the one or more deserialized email attachments may be merged into a single merged document.

In some embodiments, an email analysis module may be configured to identify one or more irrelevant email elements and one or more irrelevant attachment elements from the single merged document. The identified one or more irrelevant email elements and the identified one or more irrelevant attachment elements may then be removed from the single merged document.

In some embodiments, the email analysis module may comprise a machine learning module, an OCR module, a data extraction module, a document type identifier module and an assessment module.

In some embodiments, the email analysis module may be configured to extract body data and subject data from the deserialized email binary in the single merged document and store, in a first repository, the single merged document as a first independent transaction, wherein the first independent transaction is associated with the extracted subject data.

In some embodiments, the one or more application servers may be configured to analyze the one or more email attachments of the first customer email and identify, based on the analysis, one or more encrypted attachments from the one or more email attachments of the first customer email. Each of the one or more encrypted attachments may then be decrypted. In some embodiments, the email process module may further be configured to deserializing each of the decrypted attachments.

In some embodiments, the one or more email attachments of the first customer email may comprise one or more purchase orders, quotes, terms and conditions, requisitions, order acknowledgements, return merchandise acknowledgements, invoices, test order forms, contracts or other digital documents.

In some embodiments, identifying the one or more irrelevant attachment elements may comprise analyzing the single merged document; identifying, based on the analysis of the single merged document, one or more direct relationships between the one or more email attachments of the first customer email; and identifying, based on the analysis of the single merged document, one or more indirect relationships between the one or more email attachments of the first customer email.

In some embodiments, the email analysis module may be configured to extract an original subject line from the first customer email and create a lookup based on the extracted original subject line. The lookup may then be stored as a relationship to the one or more email attachments of the first customer email in a second repository.

In some embodiments, each of the one or more customer emails may be treated as a separate transaction, wherein each customer email may comprise a unique transaction identifier and wherein each customer email may be stored as a separate transaction in a third repository. In some embodiments, a unique data identifier may be generated for each of the one or more email attachments of the first customer email, the single merged document, the email binary, the extracted body data and the extracted subject data. In some embodiments, the unique transaction identifier and the unique data identifiers may comprise a 32 hexadecimal random value.

In some embodiments, identifying irrelevant email elements and irrelevant attachment elements may further comprise identifying one or more images in the single merged document; extracting, by the OCR module, text from the one or more identified images; comparing the extracted text against a keyword database, wherein the keyword database comprises a list of irrelevant image terms; and determining irrelevance of the one or more images based on the comparison.

In some embodiments, the first repository may be configured to generate a packet for storing the single merged document and instantiate, by a lambda function subscribed to a packet generation event on the first repository, an OCR engine. The OCR engine may comprise a trained machine learning model, wherein the machine learning model has been trained, by the machine learning module, to classify each image in the generated packet by document type and extract a custom subset of data elements for each image based on document type.

In some embodiments, the email analysis module may be further configured to create, for each image, an object file based on the extraction; store each of the object files in a fourth repository; and trigger, based on the classification and extraction of each image, one or more processes.

In some embodiments, the trained machine learning model may be trained on variations of templates for each document type.

In some embodiments, a precision score may be calculated for each extracted data element and for the single merged document as a whole.

In some embodiments, the email analysis module may further be configured to extract label/value pairs from each image; identify, based on the extracted label/value pairs, matches between images of different document types; determine, based on document type, a confidence value for each matched image; and prioritize extraction of label/value pairs from the image with the highest confidence value.

In some embodiments, the email analysis module may further be configured to determine, based on the extracted label/value pairs of each image, a deficiency in the first independent transaction and reject, based on the determined deficiency, the entire first independent transaction. The rejecting may comprise generating, based on the determined deficiency, a first exception corresponding to the first independent transaction and wherein the first exception comprises the single merged file; identifying, based on the determined deficiency, a receiving entity for the first exception; and sending, by the email analysis module, the first exception to a support agent of the receiving entity.

The appended claims may also serve as a summary of this application.

The features and components of these embodiments will be described in further detail in the description which follows. Additional features and advantages will also be set forth in the description which follows, and in part will be implicit from the description, or may be learned by the practice of the embodiments. The detailed description and specific examples are intended for illustration only and are not intended to limit the scope of the disclosure.

### BRIEF DESCRIPTION OF THE DRAWINGS

The present disclosure will become better understood from the detailed description and the drawings, wherein:

FIG. 1 is a diagram illustrating an exemplary automated email and email attachment processing system in which some embodiments may operate.

FIG. 2 is a diagram illustrating an exemplary application server in accordance with aspects of the present disclosure.

FIG. 3 is a flow chart illustrating an exemplary process flow that may be performed in accordance with some embodiments.

FIG. 4A is a flow chart illustrating an exemplary method that may be performed in accordance with some embodiments.

FIG. 4B is a diagram illustrating an exemplary method that may be performed in accordance with some embodiments.

FIG. 4C is a diagram illustrating an exemplary method that may be performed in accordance with some embodiments.

FIG. 4D is a diagram illustrating an exemplary method that may be performed in accordance with some embodiments.

FIG. 4E is a diagram illustrating an exemplary method that may be performed in accordance with some embodiments.

FIG. 5 is a diagram illustrating an exemplary computer/control system that may perform processing in some embodiments and in accordance with aspects of the present disclosure.

### DETAILED DESCRIPTION

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

The following generally relates to a system and methods for the receiving, analyzing and further processing of one or more emails and email attachments and/or one or more other documents from one or more clients.

In some embodiments, the system may be configured to receive one or more electronic documents from one or more clients. The received documents may be received through email, direct upload by a client and/or download from a cloud/interned based storage service.

In some embodiments, the emails may be read and attachments may be extracted. Images may then be filtered out before merging the read email with the extracted attachments. The extracted attachments and the merged document may be stored in separate repositories before analysis of the merged document by one or more OCR engines.

In some embodiments, the one or more OCR engines may use one or more machine learning models in the analysis of the merged documents. The machine learning models may be trained on a plurality of unique document templates, such as purchase orders, requisitions, order acknowledgements, return merchandise acknowledgements, invoices, test order forms, contracts and/or other document types.

In some embodiments, OCR engines may be configured to extract specific data from the merged document based on the training of the machine learning models. Based on the extracted data, the system may identify the type of document received from the customer.

In some embodiments, based on the type of document and the extracted data, the system may be configured to perform one or more additional assessment and/or enrichment processes on the extracted data.

In some embodiments, the system may further be configured to dynamically apply a plurality of distribution rules based on the analysis and extraction of data from the merged document. Validation and verification processes may be used to identify missing data from the merged document and one or more exceptions may be raised for the missing data. Exceptions may be forwarded to one or more support agents or support systems configured to initiate a resolution process corresponding to the missing data. The resolution process may be document type specific and adaptable to the specific data that is missing.

In some embodiments, the system may be configured to identify imperfectly submitted items from the merged document. The system may analyze the extracted data corresponding to the imperfectly submitted items and approximate a correct item that is stored in a master item database. The approximation of the correct item may be based on context and historical customer data. For example, the imperfectly submitted item may correspond to an item that a customer wishes to order, but the SKU or label may have been incorrectly entered. The system may analyze previous documents to identify similar items that have been ordered by the customer and correct the imperfectly submitted item to the previously ordered item. The order may then be generated with the corrected item in place of the imperfectly submitted item.

In some embodiments, the system may be configured to generate one or more ambiguity flags for each imperfectly submitted item. In some embodiments, one or more emails, notifications and/or exceptions may be generated for the merged document. In some embodiments, each imperfectly submitted item may have one or more flags, notifications and/or exceptions generated and combined into one or more review emails. These review emails may comprise information corresponding to the imperfectly submitted item, the identified correct item, the contextual information used to determine the correct item or other related information.

In some embodiments, the review emails may be sent to one or more support agents, one or more support systems and/or one or more customer contacts. A resolution process may be initiated for imperfectly submitted items. In some embodiments, the resolution process may include adding the review emails to the merged document and sending the emails to the support agents, support systems and customer contacts. Responses to the review emails may be analyzed by the system and based on said analysis, the system may correct the imperfectly submitted items and proceed with processing of the merged document. The responses and the corrections made may also be added to the merged document. This provides an audit trail for future analysis and logging.

In some embodiments, the resolution process may include staging a corrected document for processing with the corrected item in place of the imperfectly submitted item, sending a copy of the corrected document back to the customer, providing a description of the error/issue to the customer and providing a mechanism for response from the customer. Each step of the resolution process may be added to the merged document. In some embodiments, the mechanism for response may be a confirmation button in an email or selection made in an application, webpage or other form of communication.

In some embodiments, data that passes validation and verification may then be fed into an ERP/CRM system.

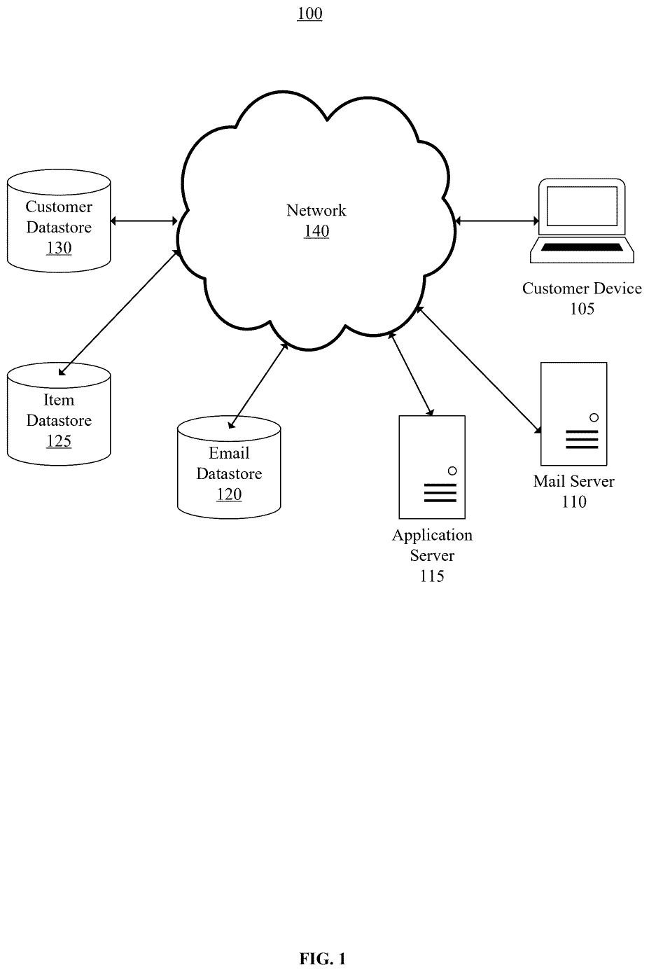

FIG. 1 is a diagram illustrating an exemplary automated email and email attachment processing system 100 in which some embodiments may operate.

The system 100 may comprise one or more client devices 105, one or more mail servers 110, one or more application servers 115, one or more email datastores 120, one or more item datastores 125, one or more customer datastores 130 and a network 140.

The client devices 105 may be one or more physical or virtual machines configured to communicate with the one or more mail servers 110, one or more application servers 115, one or more email datastores 120, one or more item datastores 125 and one or more customer datastores 130 over network 140.

The one or more mail servers 110 may be one or more physical or virtual machines configured to send and receive email documents and communication over network 140. The one or more mail servers 110 may be configured as a distributed computing infrastructure.

The one or more application servers 115 may be one or more physical or virtual machines configured to communicate with the one or more mail servers 110, one or more email datastores 120, one or more item datastores 125 and one or more customer datastores 130 over network 140. The one or more application servers 115 may further be configured to receive one or more emails from clients, customers, or other users. The one or more received emails may be analyzed and processed by the one or more application servers 115.

The one or more email datastores 120 may be configured to store one or more emails received, generated, processed and/or analyzed by the application servers 115 and/or mail servers 110. The one or more email datastores 120 may be configured to communicate with one another over network 140. Emails datastores 120 may be any storage device capable of storing data for processing or as a result of processing information at the client devices 105, mail servers 110 and/or application servers 115. The email datastores 120 may be a separate device or the same device as mail server 110 or application server 115. The email datastores 120 may be located in the same location as that of mail servers 110 and application servers 115, or at separate locations.

The one or more item datastores 125 may be configured to store one or more records corresponding to one or more items or objects. The one or more item datastores 125 may be configured to communicate with one another over network 140. Item datastores 125 may be any storage device capable of storing data for processing or as a result of processing information at the client devices 105, mail servers 110 and/or application servers 115. The item datastores 125 may be a separate device or the same device as mail server 110 or application server 115. The item datastores 125 may be located in the same location as that of mail servers 110 and application servers 115, or at separate locations.

The one or more customer datastores 130 may be configured to store one or more records corresponding to one or more customers and/or one or more customer transactions or other interactions. The one or more customer datastores 130 may be configured to communicate with one another over network 140. Customer datastores 130 may be any storage device capable of storing data for processing or as a result of processing information at the client devices 105, mail servers 110 and/or application servers 115. The customer datastores 130 may be a separate device or the same device as mail server 110 or application server 115. The customer datastores 130 may be located in the same location as that of mail servers 110 and application servers 115, or at separate locations.

Network 140 may be an intranet, internet, mesh, LTE, GSM, peer-to-peer or other communication network that allows the one or more client devices 105, one or more mail servers 110, one or more application servers 115, one or more email datastores 120, one or more item datastores 125 and one or more customer datastores 130 to communicate with one another.

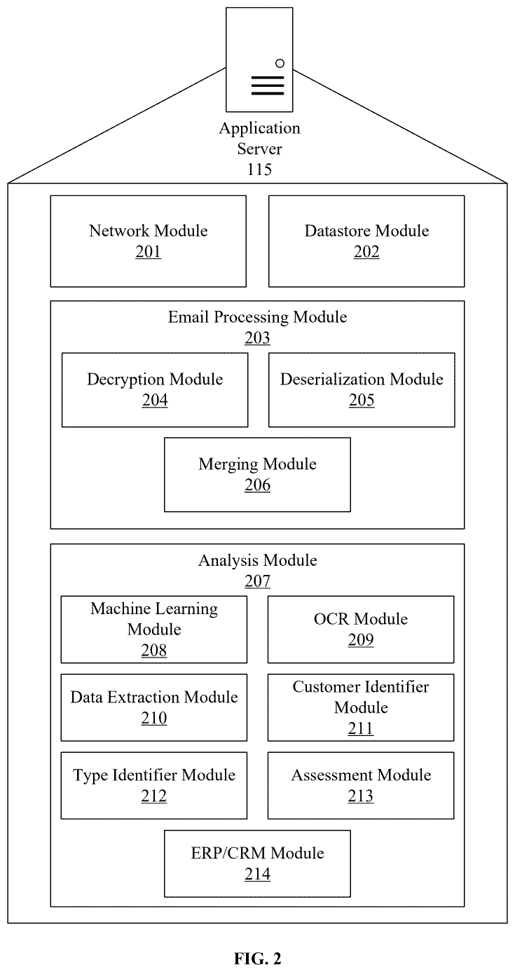

FIG. 2 is a diagram illustrating an exemplary application server 115 in accordance with aspects of the present disclosure. Application server 115 may comprise a network module 201, a datastore module 202, email processing module 203 and analysis module 207.

Network module 201 may transmit and receive data from other computing systems via a network such as network 140 as described above with regard to FIG. 1. In some embodiments, the network module 201 may enable transmitting and receiving data from the Internet. Data received by the network module 201 may be used by the other modules. The modules may transmit data through the network module 201.

The datastore module 202 may be configured to store information generated by the one or more modules operating on the application server 115. The one or more modules operating on the application server 115 may also retrieve information from the datastore module 202. Datastore module 202 may also be configured to receive and store information received over network module 201.

Email processing module 203 may further comprise decryption module 204, deserialization module 205 and merging module 206. In some embodiments, the email processing module 203 may be configured to receive, from mail servers 110, one or more customer emails. Each customer email may comprise an email binary and one or more email attachments. The received customer emails may be encrypted, unencrypted or partially encrypted. Encrypted or partially encrypted customer emails may be sent to the decryption module 204 for decryption.

Decryption module 204 may be configured to receive one or more encrypted data objects. The encrypted data objects may be emails, email attachments, or other file objects. In some embodiments, the received one or more encrypted data objects may be received with an indication of the type of document, type of encryption, encryption algorithm used, decryption library to be used or combination thereof. In some embodiments, said indications may alternatively be determined by the decryption module 204 based on analysis of the one or more encrypted data objects. The decryption module 204 may further be configured to decrypt the one or more encrypted data objects based on the received/determined indications. For example, the decryption module 204 may receive a customer email with one or more encrypted . pdf files attached. The decryption module 204 may also determine the type of encryption used and identify a decryption library compatible with the files. The encrypted . pdf files may then be decrypted with the identified decryption library. Decrypted data objects may then be used by other modules of the application server, such as the email processing module 203, deserialization module 203 and merging module 206.

The unencrypted/decrypted customer email may then be deserialized by the processing module 203. The email processing module 203 may then read the deserialized customer email and extract its one or more email attachments. In some embodiments, some or all of the email attachments may be extracted. For example, image file types such as .jpg and .png may be filtered out and not retained/extracted, while document file types such as .pdf and .doc/.docx may be extracted for retention, analysis and further processing.

In some embodiments, embedded images in the body of the email may also be filtered out or removed.

Merging module 206 may be configured to combine the subject and body of the customer email with the extracted email attachments into a single merged document. In some embodiments, the single merged document may be a . pdf file, . doc file or similar type of file. The single merged document may then be sent to the analysis module 207 for analysis and further processing.

Analysis module 207 may further comprise machine learning module 208, OCR module 209, data extraction module 210, customer identifier module 211, type identifier module 212, assessment module 213, ERP/CRM module 214. Analysis module 207 may be configured to

Machine learning module 208 may be configured to train one or more machine learning models on a plurality of document templates. In some embodiments, the templates may correspond to one or more document types. In some embodiments, one or more customer identification models may be trained and generated by the machine learning module 208.

OCR module 209 may be configured to analyze the merged documents using the one or more machine learning models trained by the machine learning module 208.

Data extraction module 210 may be configured to identify and extract data from a merged document. The data extraction module 210 may use one or more trained machine learning models in the identification and extraction of the data. One or more name/value pairs may be extracted from the merged document based on the document type and data elements identified.

Customer identifier module 211 may be configured to perform a customer identification process based on results received from the OCR module 209 and/or the data extraction module 210. In some embodiments, the customer identifier module 211 may use data from any module, such as any module operating within the analysis module 207. In some embodiments, one or more machine learning models may be used to identify the customer for each email received.

In some embodiments, the customer identifier module 211 may be configured to leverage historical data to narrow down the identity of the customer associated with a received email or document. In some embodiments, additional contextual information may also be used to identify the customer. For example, there may be multiple organizations with top level domain names for their email addresses. Different departments of an organization may have their own purchasing departments while still using the same domain name for their email addresses. Each department may be treated as a separate customer. School districts may be organized in much the same manner with multiple schools operating under the main school district.

In some embodiments, during onboarding of customers, the customers may provide a plurality of addresses associated with their account. There may be a plurality of billing and shipping addresses for each customer. Each customer may also have a default shipping and billing address. The customer information may be stored in a customer master database.

In some embodiments, the customer identification process may include extracting and matching billing and shipping addresses to customers. In some embodiments, combinations of billing and shipping addresses may be used to identify and/or differentiate the customer from other organizations that share some of the same facilities, offices and email servers. For example, two customers may have the same billing address but different delivery locations. Another example would be two customers having different billing addresses but the same delivery location.

In some embodiments, the extracted address may be an imperfect address. An imperfect address may be any address that does not match a current customer's address. An imperfect address may also include incomplete addresses and/or addresses in a nonstandard format. The customer identifier module 212 may be configured to use the imperfect address in the identification of the customer. The customer identifier module 212 may be configured to approximate a correct address based on the imperfect address. The approximation may use the imperfect address and a standardization process to generate a correct address that matches a customer.

Type identifier module 212 may be configured to identify a document type corresponding to the email attachment/merged document. The identification may be based at least in part on the OCR analysis and the extracted data from the data analysis module 210.

In some embodiments, the assessment module 213 may be configured to identify one or more items from the extracted data. The identification of items may comprise matching the extracted data to items in a master item database. In some embodiments, imperfectly submitted items in the merged document may be extracted and not matched with items in the master item database. An item correction process may be performed on these imperfectly submitted items. The item correction process may include analyzing customer history and the context of the extracted item. In some embodiments, a similarity between previously identified items in documents received from the customer may be used to identify the imperfectly submitted item. In some embodiments, descriptions of the item or other contextual information may be used to identify the correct item in the master item database.

In some embodiments, the assessment module 213 may be configured to generate one or more ambiguity flags for each imperfectly submitted item. In some embodiments, one or more emails, notifications and/or exceptions may be generated for the merged document. In some embodiments, each imperfectly submitted item may have one or more flags, notifications and/or exceptions generated and combined into one or more review emails. These review emails may comprise information corresponding to the imperfectly submitted item, the identified correct item, the contextual information used to determine the correct item or other related information.

In some embodiments, the review emails may be sent to one or more customer support agents and/or one or more customer contacts.

ERP/CRM Module 214 may be configured to generate one or more orders based on the analysis of the merged document. The ERP/CRM 312 may be updated with information from an attachment repository, a merged repository, a customer master DB and an item master DB.

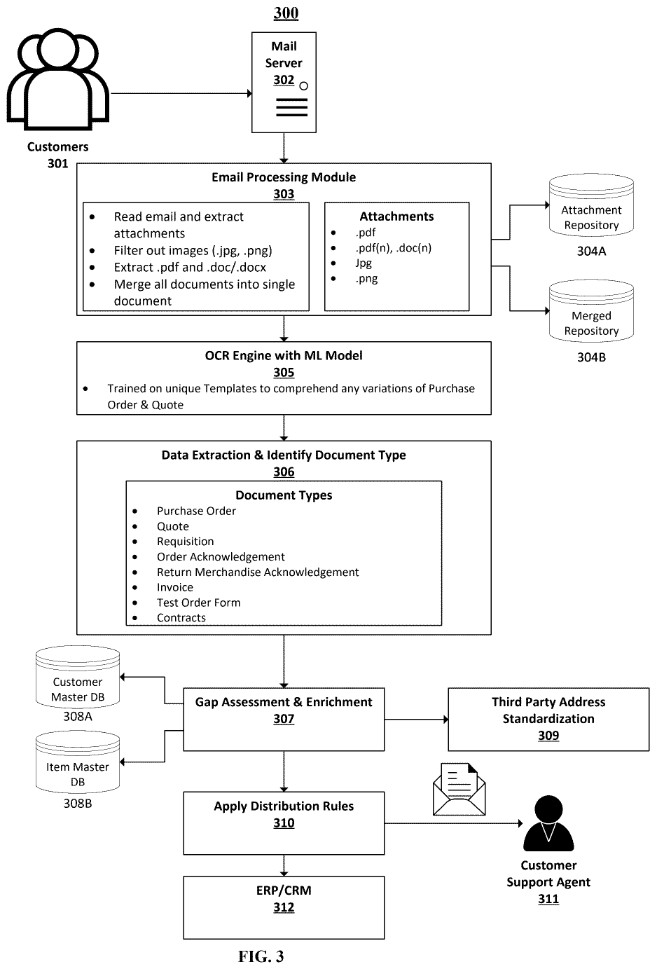

FIG. 3 is a flow chart illustrating an exemplary automated email and email attachment process flow 300 that may be performed in accordance with some embodiments. The automated email and email attachment process flow 300 may be configured to receive, from one or more customers 301, one or more documents by email, fax, mail (postal, courier or other physical delivery of documents), digital upload, file sharing platform and/or other form of document transmission. The documents may be received at mail server 302 and transferred/routed to one or more email processing modules 303. The one or more email processing modules 303 may operate on one or more servers, virtual machines or other physical or virtual computing resources.

In some embodiments, the email processing module 303 may include one or more microservices or subprocesses. The email processing module 303 may be configured to receive one or more customer emails and/or customer documents from mail server 302. The one or more customer emails may include metadata, subject text, body text, images, attachments and/or other forms of data.

In some embodiments, the email processing module 303 may be configured to deserialize the email binary of the customer email received from the mail server. In some embodiments, preprocessing may be performed on the received customer email. Preprocessing may be performed because the email may include images attached to the email body, such as email signatures, company letterhead, or other irrelevant graphical data. In some embodiments, the email may include a combination of relevant and irrelevant graphical data. The graphical data may be embedded in the body of the email as a jpeg, png or other format of image file. In some embodiments, the preprocessing may be configured to remove the irrelevant graphical data from the received customer email before storage of the email attachments or extraction of data from the body/subject of the email. The removal may be from the deserialized email binary and/or from the one or more email attachments.

After preprocessing the customer email to remove irrelevant data, the email processing module 303 may extract the subject and body from the deserialized email binary and store the email attachments into an attachment repository 304A.

In some embodiments, the email attachments may be text documents and/or image documents such as .pdf, .doc, .txt, .jpg, .png or file of any other file format.

In some embodiments, the email attachments may be encrypted. The system may be configured to identify one or more encrypted email attachments and perform a decryption process on said one or more encrypted attachments before deserialization, preprocessing and analysis of the identified one or more encrypted email attachments.

For example, an encrypted email attachment may be in the form of a PDF file or other encrypted file format. The email processing module may identify the format of the file and perform a format specific decryption of the encrypted email attachment to allow for the content to be deserialized, read and analyzed. The decryption may be performed by feeding the encrypted email attachment through a decryption library.

In some embodiments, after deserializing, reading, analyzing and removing irrelevant data/information from the customer email, a single merged document may be generated. The single merged document may comprise the deserialized email binary, data extracted from the deserialized email binary, metadata, one or more of the one or more email attachments, data extracted from the one or more email attachments and/or information generated based on the analysis of the deserialized email/email attachments.

In some embodiments, the customer email may include a purchase order, a quote, terms and conditions and/or additional documents. The additional documents may or not be directly relevant to the purchase order. In some embodiments, the additional documents may have an indirect relationship with the purchase order even if they are not directly relevant.

To ensure accurate identification of what is relevant versus what is not relevant, the email processing module may take into consideration the entire set of documents as a single transaction. The analysis and processing of the single merged document ensures that the entire set of documents is processed together.

In some embodiments, the email processing module may be configured to create a lookup corresponding to the data extracted from the customer email. The lookup may be stored as a relationship to the email attachment in the attachment repository 304A.

In some embodiments, each customer email received may be treated as separate transaction. Each of the separate transactions may, however, relate to one or more previously received customer emails (transactions). In some embodiments, the transactions may be stateless.

In some embodiments, a unique identifier may be generated for each customer email. Each email attachment and the data extracted from the customer email/attachments may also be tagged with the unique identifier.

In some embodiments, the unique identifier may be a 32 bit hexadecimal random value. The unique identifier may be generated in any manner capable of creating unique values.

In some embodiments, irrelevant information from images/graphical information may be identified by feeding them through the OCR engine module 305 to extract keywords. The extracted keywords may then be checked against a lookup table of irrelevant keywords.

In some embodiments the attachment repository 304A may comprise raw data sets of all the individual attachments of each of the customer emails. The merged repository 304B may comprise the single merged documents generated from the one or more customer emails.

In some embodiments, for each single merged document, a packet may be generated by the merged repository 304B. Upon generation of the packet, one or more events may be triggered. In some embodiments, the OCR engine may be triggered by the event and fed the corresponding generated packet.

The OCR engine module 305 may comprise one or more trained machine learning models. The one or more machine learning models may be trained to extract specific data from the generated packets (single merged document).

In some embodiments, the machine learning models may extract specific data corresponding to a purchase order and generate a json record to store the extracted data in a repository in the OCR engine module 305. The extracted data may be stored in other file formats or data structures.

The data extraction module 306 may be configured to identify a document type based on the extraction performed by the one or more machine learning modules operating in the OCR engine module 305. The one or more machine learning modules may be configured as a neural network such as a convolutional neural network. The neural network may use an underlying computer vision model to look for labels of interest in the images of the single merged document and extract name/value pairs corresponding to the identified labels. In some embodiments, the machine learning model may be configured to annotate the single merged document based on the identified labels. The annotation may include generating a bounding box around the name/value pairs of the identified labels. In some embodiments, a precision score may be generated for each extraction. The precision scores may be continually monitored to identify extracted data that fails to meet a predefined precision threshold. One or more warnings or exceptions may be raised for each extracted data element with a precision score falling below the threshold.

In some embodiments, the data extraction module 306 may be configured to identify the type of document in the single merged document. In some embodiments, the specific data extracted by the machine learning model may be based on the identified document type. For example, the single merged document may be identified as either a purchase order or a quote based on the extraction and analysis performed by the machine learning model, and different name/value pairs may be extracted for each of the document types. The data extraction module 306 may be trained to identify any number of document types and each of the document types may have a corresponding specific set of data associated with said document type.

After identifying the document type and extracting document type specific data from the single merged document, the extracted data may be validated before further processing is to be performed.

In some embodiments, failure to successfully validate the extracted data may result in an exception being generated.

Gap assessment and enrichment 307 may be configured to identify one or more items from the extracted data. The identification of items may comprise matching the extracted data to items in a master item database. In some embodiments, imperfectly submitted items in the merged document may be extracted and not matched with items in the master item database. An item correction process may be performed on these imperfectly submitted items. The item correction process may include analyzing customer history and the context of the extracted item. In some embodiments, a similarity between previously identified items in documents received from the customer may be used to identify the imperfectly submitted item. In some embodiments, descriptions of the item or other contextual information may be used to identify the correct item in the master item database.

Customer master DB 308A may comprise customer entries for every customer. Each customer entry may comprise information related to shipping addresses, billing addresses, contact information, email addresses, received documents, received emails, merged documents, other correspondence and all generated data associated with the customer. In some embodiments, each customer address may be standardized before being stored in the customer master DB. This ensures that the addresses will match when queried.

Item master DB 308B may comprise entries for a plurality of items. The entries may comprise information associated with the items. For example, each item may have a corresponding item name, SKU, description, inventory status, price and data corresponding to other associated details.

Third party address standardization 309 may be used to convert one or more addresses received from a customer to a standard format. Standardizing the addresses allows for the address to be matched against the address in the customer master DB 308A.

Apply distribution rules 310 may be configured to identify and route emails and exceptions to corresponding customer support agents, customer support teams and customers themselves.

Customer support agent 311 may receive exceptions generated as a result of missing data in the email attachment/single merged document. The customer support agent may manually perform one or more steps to resolve the problem causing the exception to be generated. In some embodiments, the customer support agent 311 may be used in the validation and verification of extracted data and processing decisions based on the extracted data. In some embodiments, the customer support agent 311 may receive an exception or validation request for data extracted/identified with a confidence or precision score falling below a predefined threshold.

ERP/CRM 312 may be configured to generate one or more orders based on the analysis of the merged document. The ERP/CRM 312 may be updated with information from attachment repository 304A, merged repository 304B, customer master DB 308A and the item master DB 308B.

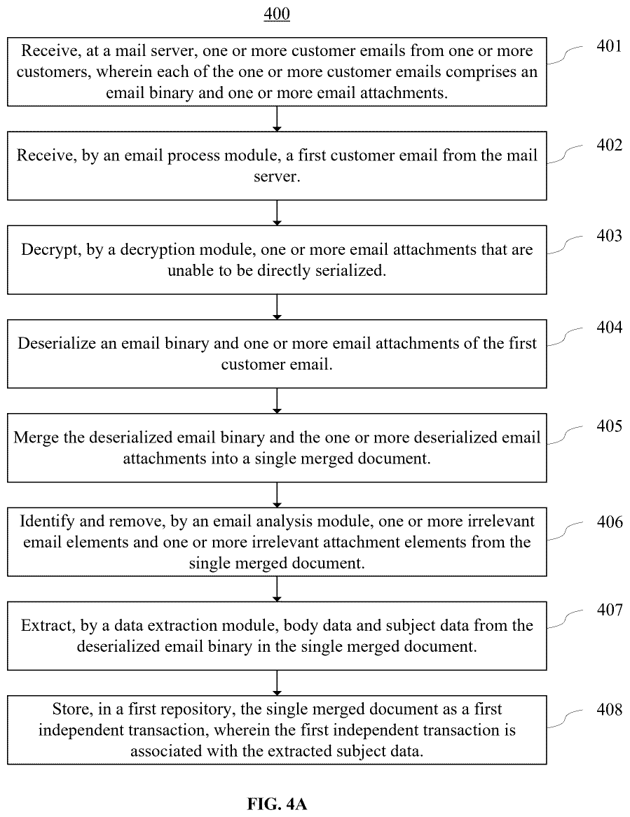

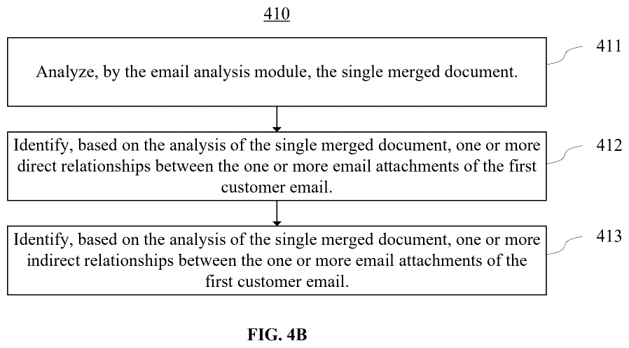

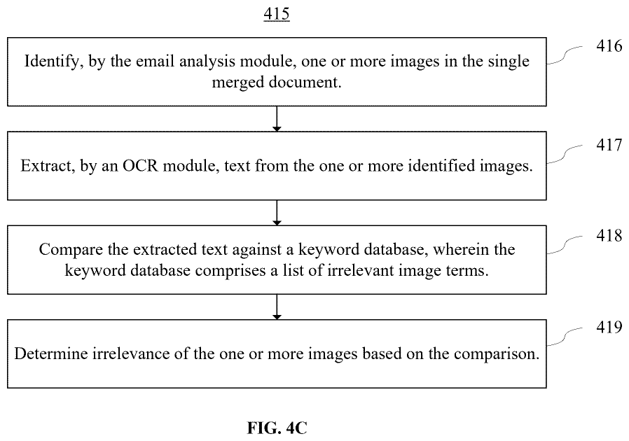

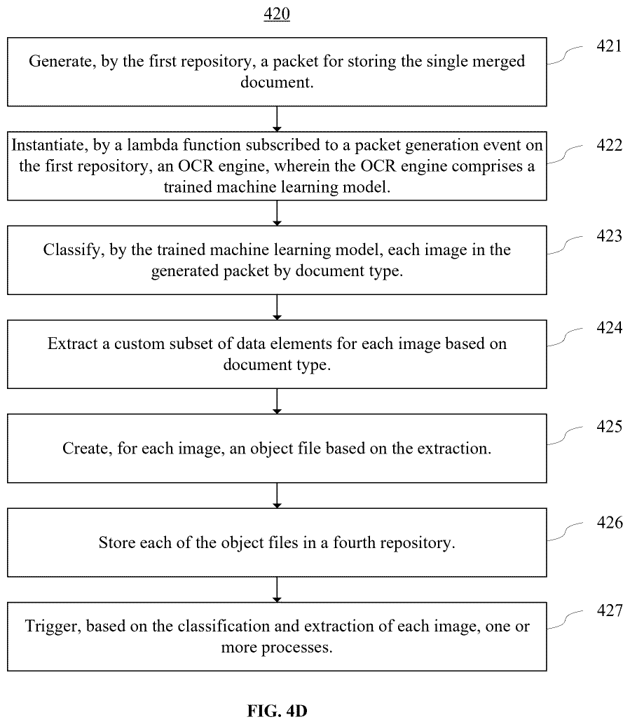

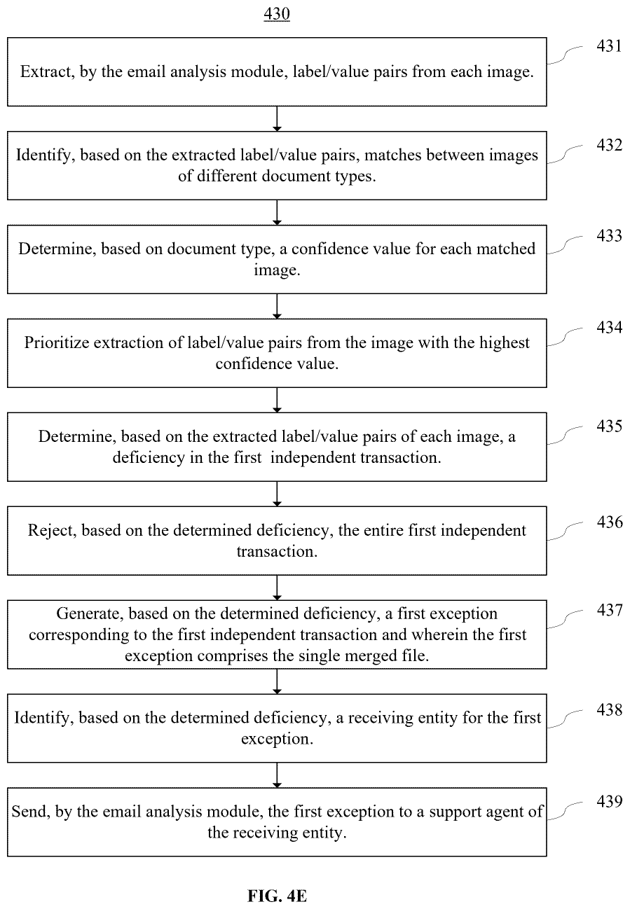

FIG. 4A is a flow chart illustrating an exemplary method for identifying and removing irrelevant email elements and attachments from a merged document 400 that may be performed in accordance with some embodiments.

At step 401, the system is configured to receive, at a mail server, one or more customer emails from one or more customers, wherein each of the one or more customer emails comprises an email binary and one or more email attachments.

At step 402, the system is configured to receive, by an email process module, a first customer email from the mail server.

At step 403, the system is configured to decrypt, by a decryption module, one or more email attachments that are unable to be directly serialized.

At step 404, the system is configured to deserialize an email binary and one or more email attachments of the first customer email.

At step 405, the system is configured to merge the deserialized email binary and the one or more deserialized email attachments into a single merged document.

At step 406, the system is configured to identify and remove, by an email analysis module, one or more irrelevant email elements and one or more irrelevant attachment elements from the single merged document.

At step 407, the system is configured to extract, by a data extraction module, body data and subject data from the deserialized email binary in the single merged document.

At step 408, the system is configured to store, in a first repository, the single merged document as a first independent transaction, wherein the first independent transaction is associated with the extracted subject data.

FIG. 4B is a flow chart illustrating an exemplary method 410 that may be performed in accordance with some embodiments.

At step 411, the system is configured to analyze, by the email analysis module, the single merged document.

At step 412, the system is configured to identify, based on the analysis of the single merged document, one or more direct relationships between the one or more email attachments of the first customer email.

At step 413, the system is configured to identify, based on the analysis of the single merged document, one or more indirect relationships between the one or more email attachments of the first customer email.

FIG. 4C is a flow chart illustrating an exemplary method 415 that may be performed in accordance with some embodiments.

At step 416, the system is configured to identify, by the email analysis module, one or more images in the single merged document.

At step 417, the system is configured to extract, by an OCR module, text from the one or more identified images.

At step 418, the system is configured to compare the extracted text against a keyword database, wherein the keyword database comprises a list of irrelevant image terms.

At step 419, the system is configured to determine irrelevance of the one or more images based on the comparison.

FIG. 4D is a flow chart illustrating an exemplary method 420 that may be performed in accordance with some embodiments.

At step 421, the system is configured to generate, by the first repository, a packet for storing the single merged document.

At step 422, the system is configured to instantiate, by a lambda function subscribed to a packet generation event on the first repository, an OCR engine, wherein the OCR engine comprises a trained machine learning model.

At step 423, the system is configured to classify, by the trained machine learning model, each image in the generated packet by document type.

At step 424, the system is configured to extract a custom subset of data elements for each image based on document type.

At step 425, the system is configured to create, for each image, an object file based on the extraction.

At step 426, the system is configured to store each of the object files in a fourth repository.

At step 427, the system is configured to trigger, based on the classification and extraction of each image, one or more processes.

FIG. 4E is a flow chart illustrating an exemplary method 430 that may be performed in accordance with some embodiments.

At step 431, the system is configured to extract, by the email analysis module, label/value pairs from each image.

At step 432, the system is configured to identify, based on the extracted label/value pairs, matches between images of different document types.

At step 433, the system is configured to determine, based on document type, a confidence value for each matched image.

At step 434, the system is configured to prioritize extraction of label/value pairs from the image with the highest confidence value.

At step 435, the system is configured to determine, based on the extracted label/value pairs of each image, a deficiency in the first independent transaction.

At step 436, the system is configured to reject, based on the determined deficiency, the entire first independent transaction.

At step 437, the system is configured to generate, based on the determined deficiency, a first exception corresponding to the first independent transaction and wherein the first exception comprises the single merged file.

At step 438, the system is configured to identify, based on the determined deficiency, a receiving entity for the first exception.

At step 439, the system is configured to send, by the email analysis module, the first exception to a support agent of the receiving entity.

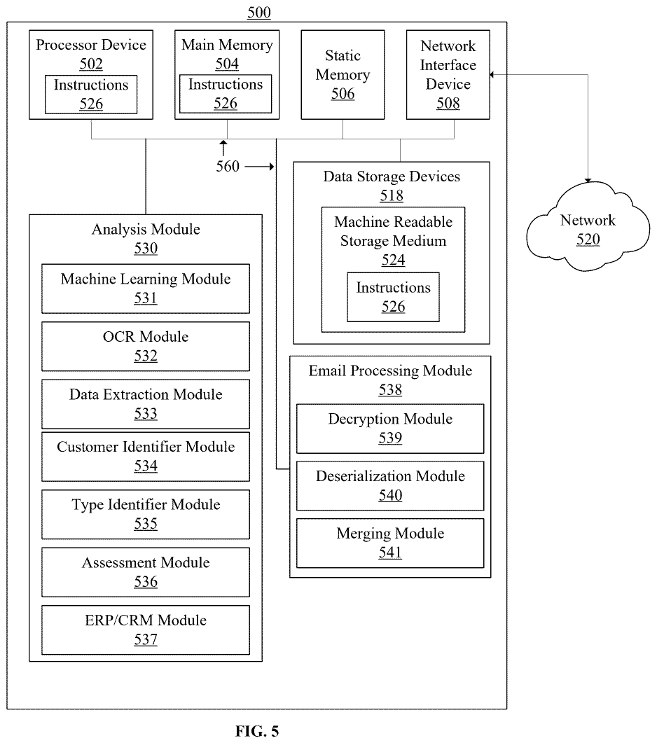

FIG. 5 illustrates an example machine of a computer system within which a set of instructions, for causing the machine to perform any one or more of the methodologies discussed herein, may be executed. In alternative implementations, the machine may be connected (e.g., networked) to other machines in a LAN, an intranet, an extranet, an ad-hoc network, a mesh network, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage device 518, which communicate with each other via a bus 560.

Processing device 502 represents one or more general-purpose processing devices such as a microprocessor, a central processing unit, or the like. More particularly, the processing device may be complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 502 may also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein.

The computer system 500 may further include a network interface device 508 to communicate over the network 520.

The computer system 500 may also include analysis module 530 and email processing module 538.

Analysis module 530 may further comprise machine learning module 531, OCR module 532, data extraction module 533, customer identifier module 534, type identifier module 535, assessment module 536 and ERP/CRM module 537.

Email processing module 538 may further comprise decryption module 539, deserialization module 540 and merging module 541.

Analysis module 530, machine learning module 531, OCR module 532, data extraction module 533, customer identifier module 534, type identifier module 535, assessment module 536, ERP/CRM module 537, email processing module 538, decryption module 539, deserialization module 540 and merging module 541 may be the same or similar to that of analysis module 207, machine learning module 208, OCR module 209, data extraction module 210, customer identifier module 211, type identifier module 212, assessment module 213, ERP/CRM module 214, decryption module 203, email processing module 204, deserialization module 205 and merging module 206 as disclosed in FIG. 2.

The data storage device 518 may include a machine-readable storage medium 524 (also known as a computer-readable medium) on which is stored one or more sets of instructions or software 526 embodying any one or more of the methodologies or functions described herein. The instructions 526 may also reside, completely or at least partially, within the main memory 504 and/or within the processing device 502 during execution thereof by the computer system 500, the main memory 504 and the processing device 502 also constituting machine-readable storage media. Information, including data used in the processes and methods of the system and the one or more sets of instructions or software, may also be stored in blockchain, as NFTs or other decentralized technologies.

In one implementation, the instructions 526 include instructions to implement functionality corresponding to the components of a device to perform the disclosure herein. While the machine-readable storage medium 524 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media and magnetic media.

It will be appreciated that the present disclosure may include any one and up to all of the following examples.

Example 1. A system for automated email and document processing, wherein the system comprises: one or more mail servers, wherein the one or more mail servers are configured to receive one or more customer emails from one or more customers, wherein each of the one or more customer emails comprises an email binary and one or more email attachments; one or more application servers, wherein the one or more application servers comprise: a decryption module, configured to decrypt one or more email attachments that are unable to be directly deserialized; an email process module, wherein the email process module is configured to: receive, from the one or more mail servers, a first customer email; deserialize an email binary of the first customer email; deserialize one or more email attachments of the first customer email; merge the deserialized email binary and the one or more deserialized email attachments into a single merged document; identify, by an email analysis module, one or more irrelevant email elements and one or more irrelevant attachment elements from the single merged document; and remove, from the single merged document, the identified one or more irrelevant email elements and the identified one or more irrelevant attachment elements; and wherein the email analysis module comprises: a machine learning module; an OCR module; a data extraction module; a document type identifier module; and an assessment module; and wherein the email analysis module is configured to: extract, by the data extraction module, body data and subject data from the deserialized email binary in the single merged document; and store, in a first repository, the single merged document as a first independent transaction, wherein the first independent transaction is associated with the extracted subject data.

Example 2. The system of Example 1, wherein the one or more application servers are configured to: analyze the one or more email attachments of the first customer email; identify, based on the analysis, one or more encrypted attachments from the one or more email attachments of the first customer email; decrypting each of the one or more encrypted attachments; and wherein the email process module is further configured to deserializing each of the decrypted attachments.

Example 3. The system of any one of Examples 1-2, wherein the one or more email attachments of the first customer email comprise: a purchase order; a quote; or terms and conditions.

Example 4. The system of any one of Examples 1-3, wherein identifying the one or more irrelevant attachment elements comprises: analyzing the single merged document; identifying, based on the analysis of the single merged document, one or more direct relationships between the one or more email attachments of the first customer email; and identifying, based on the analysis of the single merged document, one or more indirect relationships between the one or more email attachments of the first customer email.

Example 5. The system of any one of Examples 1-4, wherein the email analysis module is configured to: extract an original subject line from the first customer email; create a lookup based on the extracted original subject line; and store the lookup as a relationship to the one or more email attachments of the first customer email in a second repository.

Example 6. The system of any one of Examples 1-5, wherein each of the one or more customer emails is treated as a separate transaction, wherein each customer email comprises a unique transaction identifier and wherein each customer email is stored as a separate transaction on a third repository.

Example 7. The system of any one of Examples 1-6, wherein a unique data identifier is generated for each of the one or more email attachments of the first customer email, the single merged document, the email binary, the extracted body data and the extracted subject data.

Example 8. The system of any one of Examples 1-7, wherein the unique transaction identifier and the unique data identifiers comprise a 32 hexadecimal random value.

Example 9. The system of any one of Examples 1-8, wherein identifying irrelevant email elements and irrelevant attachment elements further comprises: identifying one or more images in the single merged document; extracting, by the OCR module, text from the one or more identified images; comparing the extracted text against a keyword database, wherein the keyword database comprises a list of irrelevant image terms; and determining irrelevance of the one or more images based on the comparison.

Example 10. The system of any one of Examples 1-9, wherein the first repository is configured to: generate a packet for storing the single merged document; instantiate, by a lambda function subscribed to a packet generation event on the first repository, an OCR engine; and wherein the OCR engine comprises a trained machine learning model, wherein the machine learning model has been trained, by the machine learning module, to classify each image in the generated packet by document type and extract a custom subset of data elements for each image based on document type.

Example 11. The system of any one of Examples 1-10, wherein the email analysis module is further configured to: create, for each image, an object file based on the extraction; store each of the object files in a fourth repository; and trigger, based on the classification and extraction of each image, one or more processes.

Example 12. The system of any one of Examples 1-11, wherein the trained machine learning model has been trained on variations of templates for each document type.

Example 13. The system of any one of Examples 1-12, wherein a precision score is calculated for each extracted data element and for the single merged document as a whole.

Example 14. The system of any one of Examples 1-13, wherein the email analysis module is further configured to: extract label/value pairs from each image; identify, based on the extracted label/value pairs, matches between images of different document types; determine, based on document type, a confidence value for each matched image; and prioritize extraction of label/value pairs from the image with the highest confidence value.

Example 15. The system of any one of Examples 1-14, wherein the email analysis module is further configured to: determine, based on the extracted label/value pairs of each image, a deficiency in the first independent transaction; reject, based on the determined deficiency, the entire first independent transaction, wherein the rejecting comprises: generating, based on the determined deficiency, a first exception corresponding to the first independent transaction and wherein the first exception comprises the single merged file; identifying, based on the determined deficiency, a receiving entity for the first exception; and sending, by the email analysis module, the first exception to a support agent of the receiving entity.

Example 16. A method for automated email and document processing, wherein the method comprises: receiving, by one or more mail servers, one or more customer emails from one or more customers, wherein each of the one or more customer emails comprises an email binary and one or more email attachments; processing, by one or more application servers, the one or more customer emails received by the one or more mail servers, wherein the processing comprises: decrypting, by a decryption module executing on the one or more application servers, one or more email attachments that are unable to be directly deserialized; receiving, by an email process module executing on the one or more application servers, a first customer email from the one or more mail servers; deserializing an email binary of the first customer email; deserializing one or more email attachments of the first customer email; merging the deserialized email binary and the one or more deserialized email attachments into a single merged document; identifying, by an email analysis module executing on the one or more application servers, one or more irrelevant email elements and one or more irrelevant attachment elements from the single merged document; and removing, from the single merged document, the identified one or more irrelevant email elements and the identified one or more irrelevant attachment elements; extracting, by a data extraction module executing in the email analysis module, body data and subject data from the deserialized email binary in the single merged document; and storing, in a first repository, the single merged document as a first independent transaction, wherein the first independent transaction is associated with the extracted subject data; and wherein the email analysis module comprises: a machine learning module; an OCR module; the data extraction module; a document type identifier module; and an assessment module.

Example 17. The method of Example 16, wherein the one or more application servers are configured to: analyze the one or more email attachments of the first customer email; identify, based on the analysis, one or more encrypted attachments from the one or more email attachments of the first customer email; decrypting each of the one or more encrypted attachments; and wherein the email process module is further configured to deserializing each of the decrypted attachments.

Example 18. The method of any one of Examples 16-17, wherein the one or more email attachments of the first customer email comprise: a purchase order; a quote; or terms and conditions.

Example 19. The method of any one of Examples 16-18, wherein identifying the one or more irrelevant attachment elements comprises: analyzing the single merged document; identifying, based on the analysis of the single merged document, one or more direct relationships between the one or more email attachments of the first customer email; and identifying, based on the analysis of the single merged document, one or more indirect relationships between the one or more email attachments of the first customer email.

Example 20. The method of any one of Examples 16-19, wherein the email analysis module is configured to: extract an original subject line from the first customer email; create a lookup based on the extracted original subject line; and store the lookup as a relationship to the one or more email attachments of the first customer email in a second repository.

Example 21. The method of any one of Examples 16-20, wherein each of the one or more customer emails is treated as a separate transaction, wherein each customer email comprises a unique transaction identifier and wherein each customer email is stored as a separate transaction on a third repository.

Example 22. The method of any one of Examples 16-21, wherein a unique data identifier is generated for each of the one or more email attachments of the first customer email, the single merged document, the email binary, the extracted body data and the extracted subject data.

Example 23. The method of any one of Examples 16-22, wherein the unique transaction identifier and the unique data identifiers comprise a 32 hexadecimal random value.

Example 24. The method of any one of Examples 16-23, wherein identifying irrelevant email elements and irrelevant attachment elements further comprises: identifying one or more images in the single merged document; extracting, by the OCR module, text from the one or more identified images; comparing the extracted text against a keyword database, wherein the keyword database comprises a list of irrelevant image terms; and determining irrelevance of the one or more images based on the comparison.

Example 25. The method of any one of Examples 16-24, wherein the first repository is configured to: generate a packet for storing the single merged document; instantiate, by a lambda function subscribed to a packet generation event on the first repository, an OCR engine; and wherein the OCR engine comprises a trained machine learning model, wherein the machine learning model has been trained, by the machine learning module, to classify each image in the generated packet by document type and extract a custom subset of data elements for each image based on document type.

Example 26. The method of any one of Examples 16-25, wherein the email analysis module is further configured to: create, for each image, an object file based on the extraction; store each of the object files in a fourth repository; and trigger, based on the classification and extraction of each image, one or more processes.

Example 27. The method of any one of Examples 16-26, wherein the trained machine learning model has been trained on variations of templates for each document type.

Example 28. The method of any one of Examples 16-27, wherein a precision score is calculated for each extracted data element and for the single merged document as a whole.

Example 29. The method of any one of Examples 16-28, wherein the email analysis module is further configured to: extract label/value pairs from each image; identify, based on the extracted label/value pairs, matches between images of different document types; determine, based on document type, a confidence value for each matched image; and prioritize extraction of label/value pairs from the image with the highest confidence value.

Example 30. The method of any one of Examples 16-29, wherein the email analysis module is further configured to: determine, based on the extracted label/value pairs of each image, a deficiency in the first independent transaction; reject, based on the determined deficiency, the entire first independent transaction, wherein the rejecting comprises: generating, based on the determined deficiency, a first exception corresponding to the first independent transaction and wherein the first exception comprises the single merged file; identifying, based on the determined deficiency, a receiving entity for the first exception; and sending, by the email analysis module, the first exception to a support agent of the receiving entity.

Example 31. A system for automated email and document processing, wherein the system comprises: one or more mail servers, wherein the one or more mail servers are configured to receive one or more customer emails from one or more customers, wherein each of the one or more customer emails comprises an email binary and one or more email attachments, and wherein each of the one or more customer emails is treated as a separate transaction, wherein each customer email comprises a unique transaction identifier and wherein each customer email is stored as a separate transaction on a third repository; one or more application servers, wherein the one or more application servers comprise: a decryption module; configured to decrypt one or more email attachments that are unable to be directly deserialized; an email process module, wherein the email process module is configured to: receive, from the one or more mail servers, a first customer email; analyze the one or more email attachments of the first customer email; identify, based on the analysis, one or more encrypted attachments from the one or more email attachments of the first customer email; decrypt, by the decryption module, each of the one or more encrypted attachments; deserialize an email binary of the first customer email; deserialize the one or more email attachments of the first customer email; merge the deserialized email binary and the one or more deserialized email attachments into a single merged document; identify, by an email analysis module, one or more irrelevant email elements and one or more irrelevant attachment elements from the single merged document, wherein the identifying comprises: analyzing the single merged document; identifying one or more images in the single merged document; extracting, by an OCR module, text from the one or more identified images; comparing the extracted text against a keyword database, wherein the keyword database comprises a list of irrelevant image terms; determining irrelevance of the one or more images based on the comparison; identifying, based on the analysis of the single merged document, one or more direct relationships between the one or more email attachments of the first customer email; and identifying, based on the analysis of the single merged document, one or more indirect relationships between the one or more email attachments of the first customer email; and remove, from the single merged document, the identified one or more irrelevant email elements and the identified one or more irrelevant attachment elements; and wherein the email analysis module comprises: a machine learning module; an OCR module; a data extraction module; a document type identifier module; and an assessment module; and wherein the email analysis module is configured to: extract, by the data extraction module, body data and subject data from the deserialized email binary in the single merged document; store, in a first repository, the single merged document as a first independent transaction, wherein the first independent transaction is associated with the extracted subject data; extract an original subject line from the first customer email; create a lookup based on the extracted original subject line; and store the lookup as a relationship to the one or more email attachments of the first customer email in a second repository.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. A system for automated email and document processing, wherein the system comprises:
one or more mail servers, wherein the one or more mail servers are configured to receive one or more customer emails from one or more customers, wherein each of the one or more customer emails comprises an email binary and one or more email attachments;
one or more application servers, wherein the one or more application servers comprise:
a decryption module, configured to decrypt one or more email attachments that are unable to be directly deserialized;
an email process module, wherein the email process module is configured to:
receive, from the one or more mail servers, a first customer email;
deserialize an email binary of the first customer email;
deserialize one or more email attachments of the first customer email;
merge the deserialized email binary and the one or more deserialized email attachments into a single merged document;
identify, by an email analysis module, one or more irrelevant email elements and one or more irrelevant attachment elements from the single merged document; and
remove, from the single merged document, the identified one or more irrelevant email elements and the identified one or more irrelevant attachment elements; and
wherein the email analysis module comprises:
a machine learning module;
an OCR module;
a data extraction module;
a document type identifier module; and
an assessment module; and
wherein the email analysis module is configured to:
extract, by the data extraction module, body data and subject data from the deserialized email binary in the single merged document; and
store, in a first repository, the single merged document as a first independent transaction, wherein the first independent transaction is associated with the extracted subject data.

2. The system of claim 1, wherein the one or more application servers are configured to:
analyze the one or more email attachments of the first customer email;
identify, based on the analysis, one or more encrypted attachments from the one or more email attachments of the first customer email;
decrypting each of the one or more encrypted attachments; and
wherein the email process module is further configured to deserializing each of the decrypted attachments.

3. The system of claim 2, wherein the one or more email attachments of the first customer email comprise:
a purchase order;
a quote; or
terms and conditions.

4. The system of claim 3, wherein identifying the one or more irrelevant attachment elements comprises:
analyzing the single merged document;
identifying, based on the analysis of the single merged document, one or more direct relationships between the one or more email attachments of the first customer email; and
identifying, based on the analysis of the single merged document, one or more indirect relationships between the one or more email attachments of the first customer email.

5. The system of claim 4, wherein the email analysis module is configured to:
extract an original subject line from the first customer email;
create a lookup based on the extracted original subject line; and
store the lookup as a relationship to the one or more email attachments of the first customer email in a second repository.

6. The system of claim 5, wherein each of the one or more customer emails is treated as a separate transaction, wherein each customer email comprises a unique transaction identifier and wherein each customer email is stored as a separate transaction on a third repository.

7. The system of claim 6, wherein a unique data identifier is generated for each of the one or more email attachments of the first customer email, the single merged document, the email binary, the extracted body data and the extracted subject data.

8. The system of claim 7, wherein the unique transaction identifier and the unique data identifiers comprise a 32 hexadecimal random value.

9. The system of claim 8, wherein identifying irrelevant email elements and irrelevant attachment elements further comprises:
identifying one or more images in the single merged document;
extracting, by the OCR module, text from the one or more identified images;
comparing the extracted text against a keyword database, wherein the keyword database comprises a list of irrelevant image terms; and
determining irrelevance of the one or more images based on the comparison.

10. The system of claim 9, wherein the first repository is configured to:
generate a packet for storing the single merged document;
instantiate, by a lambda function subscribed to a packet generation event on the first repository, an OCR engine; and
wherein the OCR engine comprises a trained machine learning model, wherein the machine learning model has been trained, by the machine learning module, to classify each image in the generated packet by document type and extract a custom subset of data elements for each image based on document type.

11. The system of claim 10, wherein the email analysis module is further configured to:
create, for each image, an object file based on the extraction;
store each of the object files in a fourth repository; and
trigger, based on the classification and extraction of each image, one or more processes.

12. The system of claim 11, wherein the trained machine learning model has been trained on variations of templates for each document type.

13. The system of claim 12, wherein a precision score is calculated for each extracted data element and for the single merged document as a whole.

14. The system of claim 13, wherein the email analysis module is further configured to:
extract label/value pairs from each image;
identify, based on the extracted label/value pairs, matches between images of different document types;
determine, based on document type, a confidence value for each matched image; and
prioritize extraction of label/value pairs from the image with the highest confidence value.

15. The system of claim 14, wherein the email analysis module is further configured to:
determine, based on the extracted label/value pairs of each image, a deficiency in the first independent transaction;
reject, based on the determined deficiency, the entire first independent transaction, wherein the rejecting comprises:
generating, based on the determined deficiency, a first exception corresponding to the first independent transaction and wherein the first exception comprises the single merged file;
identifying, based on the determined deficiency, a receiving entity for the first exception; and
sending, by the email analysis module, the first exception to a support agent of the receiving entity.

16. A method for automated email and document processing, wherein the method comprises:
receiving, by one or more mail servers, one or more customer emails from one or more customers, wherein each of the one or more customer emails comprises an email binary and one or more email attachments;
processing, by one or more application servers, the one or more customer emails received by the one or more mail servers, wherein the processing comprises:
decrypting, by a decryption module executing on the one or more application servers, one or more email attachments that are unable to be directly deserialized;
receiving, by an email process module executing on the one or more application servers, a first customer email from the one or more mail servers;
deserializing an email binary of the first customer email;
deserializing one or more email attachments of the first customer email;
merging the deserialized email binary and the one or more deserialized email attachments into a single merged document;
identifying, by an email analysis module executing on the one or more application servers, one or more irrelevant email elements and one or more irrelevant attachment elements from the single merged document; and
removing, from the single merged document, the identified one or more irrelevant email elements and the identified one or more irrelevant attachment elements;
extracting, by a data extraction module executing in the email analysis module, body data and subject data from the deserialized email binary in the single merged document; and
storing, in a first repository, the single merged document as a first independent transaction, wherein the first independent transaction is associated with the extracted subject data; and
wherein the email analysis module comprises:
a machine learning module;
an OCR module;
the data extraction module;
a document type identifier module; and
an assessment module.

17. The method of claim 16, wherein the one or more application servers are configured to:
analyze the one or more email attachments of the first customer email;
identify, based on the analysis, one or more encrypted attachments from the one or more email attachments of the first customer email;
decrypting each of the one or more encrypted attachments; and
wherein the email process module is further configured to deserializing each of the decrypted attachments.

18. The method of claim 17, wherein the one or more email attachments of the first customer email comprise:
a purchase order;
a quote; or
terms and conditions.

19. The method of claim 18, wherein identifying the one or more irrelevant attachment elements
comprises:
analyzing the single merged document;
identifying, based on the analysis of the single merged document, one or more direct relationships between the one or more email attachments of the first customer email; and
identifying, based on the analysis of the single merged document, one or more indirect relationships between the one or more email attachments of the first customer email.

20. The method of claim 19, wherein the email analysis module is configured to:
extract an original subject line from the first customer email;
create a lookup based on the extracted original subject line; and
store the lookup as a relationship to the one or more email attachments of the first customer email in a second repository.

21. The method of claim 20, wherein each of the one or more customer emails is treated as a separate transaction, wherein each customer email comprises a unique transaction identifier and wherein each customer email is stored as a separate transaction on a third repository.

22. The method of claim 21, wherein a unique data identifier is generated for each of the one or more email attachments of the first customer email, the single merged document, the email binary, the extracted body data and the extracted subject data.

23. The method of claim 22, wherein the unique transaction identifier and the unique data identifiers comprise a 32 hexadecimal random value.

24. The method of claim 23, wherein identifying irrelevant email elements and irrelevant
attachment elements further comprises:
identifying one or more images in the single merged document;
extracting, by the OCR module, text from the one or more identified images;
comparing the extracted text against a keyword database, wherein the keyword database comprises a list of irrelevant image terms; and
determining irrelevance of the one or more images based on the comparison.

25. The method of claim 24, wherein the first repository is configured to:
generate a packet for storing the single merged document;
instantiate, by a lambda function subscribed to a packet generation event on the first repository, an OCR engine; and
wherein the OCR engine comprises a trained machine learning model, wherein the machine learning model has been trained, by the machine learning module, to classify each image in the generated packet by document type and extract a custom subset of data elements for each image based on document type.

26. The method of claim 25, wherein the email analysis module is further configured to:
create, for each image, an object file based on the extraction;
store each of the object files in a fourth repository; and
trigger, based on the classification and extraction of each image, one or more processes.

27. The method of claim 26, wherein the trained machine learning model has been trained on variations of templates for each document type.

28. The method of claim 27, wherein a precision score is calculated for each extracted data element and for the single merged document as a whole.

29. The method of claim 28, wherein the email analysis module is further configured to:
extract label/value pairs from each image;
identify, based on the extracted label/value pairs, matches between images of different document types;
determine, based on document type, a confidence value for each matched image; and
prioritize extraction of label/value pairs from the image with the highest confidence value.

30. The method of claim 29, wherein the email analysis module is further configured to:
determine, based on the extracted label/value pairs of each image, a deficiency in the first independent transaction;
reject, based on the determined deficiency, the entire first independent transaction, wherein the rejecting comprises:
generating, based on the determined deficiency, a first exception corresponding to the first independent transaction and wherein the first exception comprises the single merged file;
identifying, based on the determined deficiency, a receiving entity for the first exception; and
sending, by the email analysis module, the first exception to a support agent of the receiving entity.

31. A system for automated email and document processing, wherein the system comprises:
one or more mail servers, wherein the one or more mail servers are configured to receive one or more customer emails from one or more customers, wherein each of the one or more customer emails comprises an email binary and one or more email attachments, and wherein each of the one or more customer emails is treated as a separate transaction, wherein each customer email comprises a unique transaction identifier and wherein each customer email is stored as a separate transaction on a third repository;
one or more application servers, wherein the one or more application servers comprise:
a decryption module; configured to decrypt one or more email attachments that are unable to be directly deserialized;
an email process module, wherein the email process module is configured to:
receive, from the one or more mail servers, a first customer email;
analyze the one or more email attachments of the first customer email;
identify, based on the analysis, one or more encrypted attachments from the one or more email attachments of the first customer email;
decrypt, by the decryption module, each of the one or more encrypted attachments;
deserialize an email binary of the first customer email;
deserialize the one or more email attachments of the first customer email;
merge the deserialized email binary and the one or more deserialized email attachments into a single merged document;
identify, by an email analysis module, one or more irrelevant email elements and one or more irrelevant attachment elements from the single merged document, wherein the identifying comprises:
analyzing the single merged document;
identifying one or more images in the single merged document;
extracting, by an OCR module, text from the one or more identified images;
comparing the extracted text against a keyword database, wherein the keyword database comprises a list of irrelevant image terms;
determining irrelevance of the one or more images based on the comparison;
identifying, based on the analysis of the single merged document, one or more direct relationships between the one or more email attachments of the first customer email; and
identifying, based on the analysis of the single merged document, one or more indirect relationships between the one or more email attachments of the first customer email; and
remove, from the single merged document, the identified one or more irrelevant email elements and the identified one or more irrelevant attachment elements; and
wherein the email analysis module comprises:
a machine learning module;
an OCR module;
a data extraction module;
a document type identifier module; and
an assessment module; and
wherein the email analysis module is configured to:
extract, by the data extraction module, body data and subject data from the deserialized email binary in the single merged document;
store, in a first repository, the single merged document as a first independent transaction, wherein the first independent transaction is associated with the extracted subject data;
extract an original subject line from the first customer email;
create a lookup based on the extracted original subject line; and
store the lookup as a relationship to the one or more email attachments of the first customer email in a second repository.
